(19) United States
(12) Patent Application Publication
(10) Pub. No.: US 2008/0174178 A1
(43) Pub. Date: Jul. 24, 2008

(54) Field bus interface

(76) Inventors: Roland Jakobsson, Askim (SE); Valter Nilsson, Hovas (SE)

Correspondence Address: WESTMAN CHAMPLIN & KELLY, P.A., SUITE 1400, 900 SECOND AVENUE SOUTH, MINNEAPOLIS, MN, 55402-3244, US

(21) Appl. No.: 11/656,124

(22) Filed: Jan. 22, 2007

(51) Int. Cl. H02J 3/00

(52) U.S. Cl. 307/31

(57) ABSTRACT

A field bus interface for connecting a device to a field bus, comprising communication circuitry for providing communication via the field bus, first power supply circuitry arranged to provide said communication circuit with a predefined communication power at a predefined drive voltage, and second power supply circuitry arranged to provide a processing circuitry with processing power at said bus voltage only when a power available from said field bus exceeds said communication power.

More specifically, the power provided to the processing circuitry at a given bus current will be decided by the power actually available, instead of a power level decided by the lower limit of the voltage range of the field bus specification. The first circuitry and the communication circuitry will ensure that the field bus requirements are met in a case when the bus voltage falls close to the lower limit of the bus voltage range.

### FIELD OF THE INVENTION

The present invention relates to a field bus interface.

### BACKGROUND OF THE INVENTION

Industrial field buses, e.g. according to IEC 61158-2 (such as Foundation Fieldbus, Profibus Pa.), are increasingly utilized in instrumentation systems. They reduce the cost for installation and cabling, as several devices (nodes) can be connected to the same bus. The bus provides power supply and communication with the devices.

When devices on the bus are installed in hazardous areas, measures must be taken to provide explosion protection. One solution is to ensure intrinsic safety, i.e. to limit currents, voltages and power so as to eliminate the risk of spark ignition.

A consequence of the field bus physical layer requirements is that the devices should draw a predefined current independent of the bus voltage in a specified range, having a lower limit in accordance with the field bus standard, e.g. 9 V. The upper limit is adapted to allow for compensation of voltage drops in IS barriers and long cables.

The requirements of intrinsic safety (e.g. IEC 60079-11) severely limit the number of devices that can be connected to a bus without exceeding the power limits. An improvement in this respect is the FISCO specification (IEC TS 60079-27) which allows 4-5 times higher power output from the power supply unit.

In order to be functional at the lower limit of the voltage range, any device needs to be dimensioned to a power consumption defined by this lower voltage and the required bus current. A bus interface is arranged to handle any variation in bus voltage, i.e. any additional power during periods when the bus voltage exceeds the lower limit. Typically, such an interface comprises a current sink, ensuring the required current, and dissipating any surplus power as heat.

A consequence of the FISCO specification is that intrinsically safe devices within a bounded area (where the field bus cables are relatively short) never experience the specified minimum voltage. However, as explained above, any additional power available at a higher voltage will not be effectively used in conventional devices, only wasted in the current sink. One example of such a situation is a limited bus segment powering various instruments arranged to measure process variables of a product in a tank.

### SUMMARY OF THE INVENTION

It is therefore an object of the present invention to achieve improved efficiency in an intrinsically safe bus powered field device, while still fulfilling the standard specification.

This and other objects are achieved by a field device comprising communication circuitry for providing communication via the field bus, first power supply circuitry connected to said field bus and arranged to provide said communication circuit with a predefined communication power at a predefined drive voltage, said drive voltage being lower than a lower limit of said bus voltage range, and second power supply circuitry connected to said field bus and arranged to provide a processing circuitry with processing power at said bus voltage only when a power available from said field bus exceeds said communication power.

According to the invention, the second circuitry will provide the processing circuitry with any surplus power that is available in addition to the communication power required by the communication circuitry. In a case where the bus voltage is at, or very close to, the lower limit of the bus voltage range, essentially all available power will be used by the first power supply circuitry and the communication circuitry, resulting in no, or very little, surplus power. However, when the bus voltage increases, any power exceeding the required communication power can be provided to the processing circuitry.

It should be noted that the processing circuitry or the device connected to the interface may comprise energy stores, in which case the power may not be used immediately but stored for later use.

In a situation where the voltage from the bus normally is greater than the lower limit of the field bus specification voltage range, this means that the processing circuitry will be able to more effectively use the available power. More specifically, the power provided to the processing circuitry at a given bus current will be decided by the power actually available, instead of a power level decided by the lower limit of the voltage range of the field bus specification. The first circuitry and the communication circuitry will ensure that the field bus requirements are met in a case when the bus voltage falls close to the lower limit of the bus voltage range.

In a typical case, the lower limit of the voltage range required by the field bus specification is 9 V, corresponding to a minimum power at a given bus current. Typically, however, the field devices are provided with around 12 V, corresponding to a greater available power. By providing the processing circuitry with all available power, the present invention can therefore increase the power delivered to the processing circuitry by around one third at a given bus current. Such additional power may be used e.g. to increase the measurement range and/or improve the resolution and thereby accuracy of the instrument. The present invention may be combined with various types of energy storage, to improve performance even further.

Alternatively, the invention can reduce the required bus current by one quarter, potentially increasing the number of field devices on the bus segment by the same fraction.

Preferably, the device comprises a detector for detecting a surplus power, corresponding to said available power level reduced by said communication power. This surplus power is the maximum power that can be delivered to the processing circuitry. The detector, which may comprise a voltage sensor, can be connected to a controller arranged to adapt a functionality of the processing circuitry in accordance with the detected surplus power. By detecting the surplus power, the device can thus adopt its power consumption in dependence of the available power. This enables a further improvement in power efficiency.

A process instrument, such as a radar level gauge, may be designed to provide only a basic functionality at the minimum input voltage level. When a higher input voltage is sensed, the instrument may use the extra available power to increase measuring accuracy or extend the measuring range or improve any other performance parameter of choice.

According to one embodiment, the processing circuitry is adapted to interface and supply power to a current loop, such as a 4-20 mA industrial loop. In such a case, the field bus interface can act as a gateway between a field bus and another commnunication bus such as a HART bus.

A bus interface according to an embodiment of the present invention can advantageously be used in a process gauge, for example in a Radar Level Gauge (RLG). In this case, the processing circuitry can comprise a transceiver for transmitting and receiving electromagnetic signals, and measurement circuitry for determining a process variable based on a relationship between said transmitted signal and received signals. The transceiver can be connected to a propagation device arranged to allow the transmitted signal to propagate towards a surface of a product in a tank and to return a reflected signal to the transceiver.

The performance of a radar level gauges can typically be increased if additional power can be made available. At the same time, RLGs are often arranged in hazardous areas, thus requiring intrinsically safe power supply. The conflict between limited power supply and improved performance can be mitigated by a field bus interface according to an embodiment of the present invention.

### BRIEF DESCRIPTION OF THE DRAWINGS

This and other aspects of the present invention will now be described in more detail, with reference to the appended drawings showing a currently preferred embodiment of the invention.

FIG. 1 is a schematic circuit diagram of a field bus interface according to the prior art.

FIG. 2 is a schematic circuit diagram of a field bus interface according to an embodiment of the present invention.

FIG. 3 is a schematic block diagram of the interface in FIG. 2 connected to a radar level gauge via a two-wire interface.

FIG. 4 is a schematic block diagram of the interface in FIG. 2 connected to a two-wire bus having several nodes.

### DETAILED DESCRIPTION OF CURRENTLY PREFERRED EMBODIMENTS

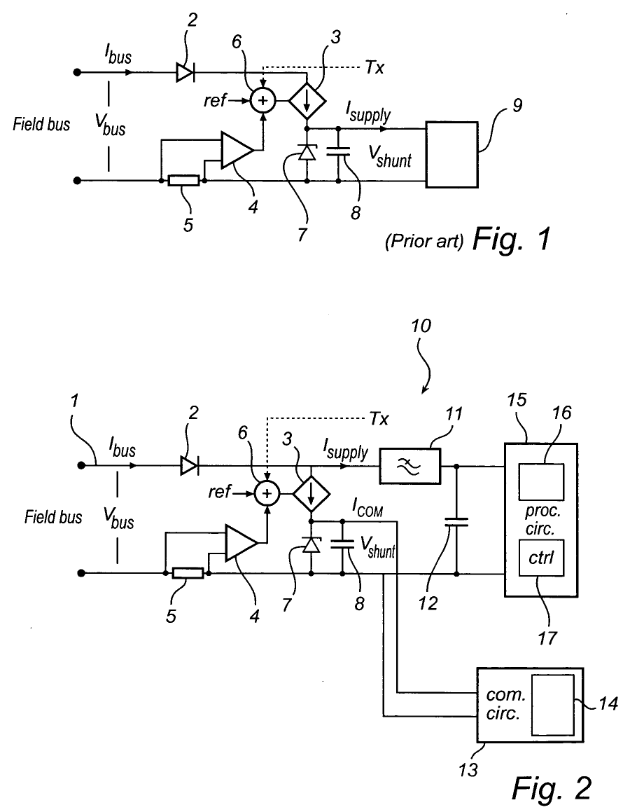

FIG. 1 shows a field bus interface between an intrinsically safe field bus 1 and a bus powered device 9, such a process instrument. As indicated in FIG. 1, the interface draws a preset average current I_{bus} from the bus at a voltage V_{bus} which is allowed to vary within a certain range, e.g. 9-32 V. The interface comprises a diode 2 in series with a controllable current source 3. A current feedback path in the form of an operational amplifier 4 arranged to detect the voltage difference over a resistor 5, is arranged to provide a current feedback signal to an adder 6, where it is subtracted from a current set point (ref). The resulting difference is provided as a control signal (ctrl) to the current source 3. Optionally, the adder 6 is also provided with a timing signal Tx, indicating the timing of an alternating signal current modulated on the bus current.

Between the output of the current source 3 and the resistor 5 is connected a shunt regulator, here a zener diode 7, in parallel with a capacitor 8, for ensuring a constant voltage (Vₛₕᵤₙₜ) across the capacitor equal to the zener break down voltage. This voltage is the drive voltage made available to the field device, regardless of the available voltage on the bus, and in combination with the constant bus current it defines the power available to the device 9. The device 9 typically includes a DC/DC switching regulator connected to the constant voltage Vₛₕᵤₙₜ, and arranged to provide any voltage levels required by the device 9.

In a typical situation, where the field bus fulfills the Foundation Fieldbus specification, the device 9 must be adapted to a supply voltage of 9 V. This results in a voltage Vₛₕᵤₙₜ across the capacitor 8 of around 7 V (the threshold voltage of the zener diode 7). The device 9 is adapted to draw a constant power at this voltage level, resulting in a constant current I_{supply}. The current source 3 will act as a current sink, controlled by the current feedback 4, 5, to ensure that the bus current I_{bus} stays close to the required current. For supply voltages exceeding 9 V, the surplus power will be absorbed by the current source, and will be dissipated as heat.

FIG. 2 shows a field bus interface 10 according to an embodiment of the present invention. Elements having similar function as corresponding elements in FIG. 1 have been given identical reference numbers, and will not be described in detail.

The process instrument, to which the processing circuitry 15 belongs, can be a gauging instrument arranged to measure a process variable of a an explosive product such as hydrocarbon contained in a tank. Such instruments include pressure transmitters, temperature transmitters, level gauges, etc. The interface is typically a two-wire interface, i.e. power supply and signal communication are achieved using only two wires. In a field bus system, the signal communication is typically achieved by modulating an alternating current on the constant bus current. This alternating current allows for digital communication according to e.g. the Foundation Fieldbus, or Profibus PA protocol.

As is clear from FIG. 2, a simulated inductance 11 and a capacitor 12 are connected in series between the input of the current source 3 and the anode of the zener diode 7. The simulated inductance 11 adapted to prevent current variations with a time constant in the order of the communication signal frequency. In other words, the inductance 11 acts as a current source which only slowly changes its current.

A communication circuitry 13, including a data link controller 14 and a media access unit, is connected to the voltage across the zener diode 7. The communication circuitry 13 is adapted to consume a constant power. As the zener diode 7 will ensure a constant voltage Vₛₕᵤₙₜ to the communication circuitry 13, the required current I_{com} will also be constant. The communication circuitry 13 is adapted to provide all functions required by the field bus specification, thereby ensuring that the field device fulfills the requirements as long as the bus voltage is large enough to uphold the threshold voltage across the zener diode 7.

A processing circuitry 15 is connected to a supply voltage V_{supply} across the capacitor 12. The supply voltage is slightly smaller than the available bus voltage V_{bus}, due to voltage drops e.g. across the inductance 11. The processing circuitry 15 comprises a detector 16 for detecting any available power exceeding the constant power drawn by the communication circuitry 13, and a controller 17. The detector 16 can for example be realized by a voltage sensor arranged to measure the voltage across the capacitor 12. The controller 17 is arranged to adapt the functionality of the processing circuitry 15 in accordance with the available surplus power.

In FIG. 2, the communication circuitry 13 and the processing circuitry 15 have been illustrated as separate blocks. However, it should be realized that these blocks may well be different parts of a single, interconnected circuitry, where one part (the communication circuitry) is powered by a first power supply circuitry (comprising the current source 3, its feedback path 4, 5, the zener diode 7 and capacitor 8), and the other part (the processing circuitry) is powered by a second power supply circuitry (comprising the inductance 11 and capacitor 12).

The function of the bus interface 10 will be described in the following.

The first power supply circuitry will require a given voltage (Vₘᵢₙ) to provide the power required by the communication circuitry. In order to fulfill the field bus specification, this voltage must be no greater than the lower limit of the required supply voltage range. In a typical case (e.g. Foundation Fieldbus specification) this lower limit is 9 V.

At higher bus voltages, a surplus power, equal to the difference between the supply voltage V_{bus} and Vₘᵢₙ multiplied by the bus current I_{bus}, will be available to the processing circuitry 15, and detected by the detector 16. Based on the detected power, the controller 17 will adjust the functionality of the processing circuitry to the available power. In the simplest case, when the available power is insufficient for any functionality, the processing circuitry will be inactivated. Any surplus power, not consumed by the communication circuitry 13, will then be consumed by the current source 3 (e.g. dissipated as heat). The current source 3 will now, just as in FIG. 1, acting as a current sink to maintain the required bus current I_{bus}, and any current exceeding I_{com} will flow through the zener diode 7.

As the bus voltage increases, more power will become available to the processing circuitry. At a given threshold, the controller 17 will activate a minimum functionality of the processing circuitry 15. Such low power functionality may include a low resolution measurement of a process variable. The activation of the processing circuitry will result in a power consumption, and thus a drive current I_{supply}, depending on the required power and the available voltage. The detector 16 will continue to detect the supply voltage so that the controller 17 can activate additional functionality as more power becomes available. Such functionality may include e.g. a higher resolution measurement of the process variable.

The maximum current I_{supply,max} available to the processing circuitry at any given moment is I_{bus}-I_{com}, which will be the case when all power is delivered to the processing circuitry and communication circuitry, respectively. In practice, there will of course be a small leakage of power in the interface itself, but this is not relevant for the principles of the invention, and will not be discussed for simplicity. This maximum value of I_{supply}, in combination with the lowest power required by the processing circuitry 15 to provide the functionality selected by the controller 17, will define a lowest acceptable supply voltage V_{supply, min} to activate this functionality.

When the voltage provided by the bus is greater than this voltage threshold, V_{supply, min}, the current I_{supply} will decrease if the power required by the processing circuitry 15 do provide the selected functionality is constant. In this case, the surplus power, i.e. the difference between the supply voltage V_{supply} and the voltage threshold V_{supply,min} multiplied by the bus current I_{bus}, will be consumed by the current source (e.g. dissipated as heat).

Alternatively, or in combination, the processing circuitry maybe arranged to draw a variable power when providing a selected functionality. In other words, the processing circuitry can be adapted to provide a selected functionality with any power (over a minimum level) that is available. When the available power increases, this can be utilized by the processing circuitry, e.g. for power storage. When the voltage provided by the bus is less than the voltage threshold, V_{supply, min}, the power required by the selected functionality can no longer be provided to the processing circuitry. At this point, the controller 17 will therefore control the processing circuitry 15 to reduce its functionality, so as to require less power. When not even the minimum functionality can be provided, the controller 17 will completely deactivate the processing circuitry.

The person skilled in the art realizes that the present invention by no means is limited to the preferred embodiments described above. On the contrary, many modifications and variations are possible within the scope of the appended claims. For example, the controller 17 may be functionally located in the communication circuitry 13 rather than in the processing circuitry 15, so as to be powered by the first power supply circuitry. This has the advantage that the control of the processing circuitry 15 will be guaranteed at all voltages (within the specified voltage range).

The bus interface 10 herein described can advantageously be used to interface various devices, including various process gauges. In a simple case, the bus interface 10 can be a integral part of the device, in which case the processing circuitry 15 includes e.g. gauging circuitry.

Alternatively, the interface 10 is used in a separate device in order to connect another process instrument to the field bus. The other instrument may for example have an analog current loop interface, such as a 4-20 mA industrial loop, and the processing circuitry 15 of the bus interface 10 is adapted to communicate with the instrument via the current loop. In this case, as the field bus voltage increases, the processing circuitry 15 may provide a higher loop voltage to the connected instrument.

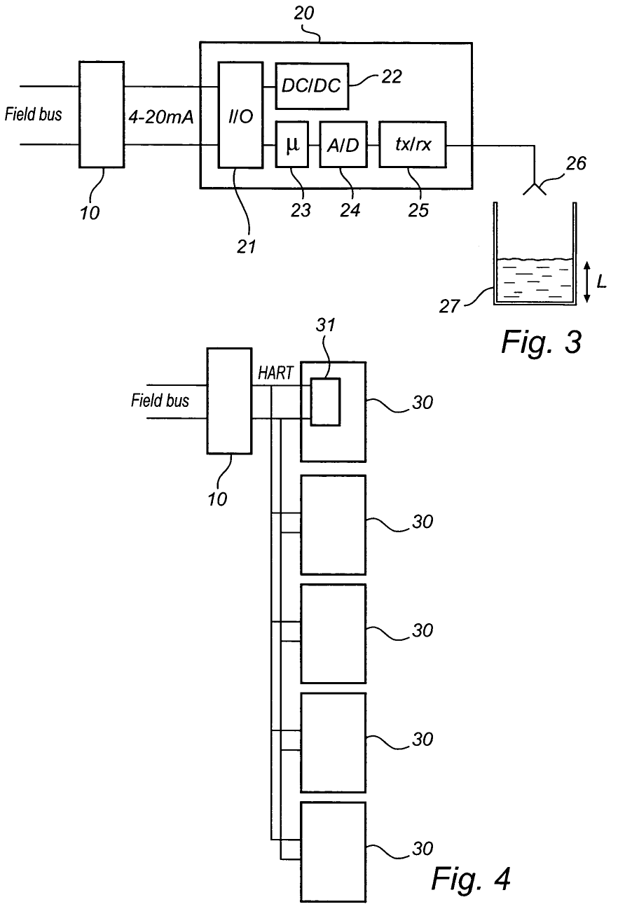

An example of a radar level gauge 20 connected to a field bus interface 10 according to an embodiment of the invention is shown in FIG. 3. The level gauge 20 here comprises an I/O unit 21 for maintaining the analog signal to the bus interface 10. The processing circuitry 15 of the bus interface 10 is in this case adapted to power the current loop and sense the output signal from this I/O unit 21, e.g. using digital or analogue HART.

The I/O-unit can, as mentioned, be arranged to communicate over a 4-20 mA industrial loop, in which case a signal level is communicated by regulating the current in the loop. A DC/DC converter 22 is connected to I/O-unit 21, and is arranged to supply the gauging circuitry with power at various voltage levels. The gauging circuitry comprises a processor 23, an A/D-converter 24, and a transceiver 25, as known in the art per se.

The transceiver is connected to a propagation device 26, such as an antenna or guided wave probe, arranged to allow a transmitted signal to propagate into a tank 27. The transmitted signal is reflected by a surface of a product in the tank, and a reflected signal is returned to the transceiver, where it is received. The measurement circuitry is arranged to determine a process variable, such as the product level L, based on a relation between transmitted and received signals.

Another example is illustrated in FIG. 4. Here, the bus interface 10 is used to interface several instruments 30 arranged to be powered by a two wire bus. An example of such a bus is a HART bus, where each connected device is provided with a 4 mA current and communicate by modulating digital signals on the bus.

The instruments 30 may be various types of process equipment. When such equipment is connected by a HART bus, it includes a HART modem 31, adapted to interface with the bus. According to the HART specification, each device can draw 4 mA. This means that a limited number of such devices can be powered by an intrinsically safe field bus. By implementing an interface 10 according to an embodiment of the invention as a gateway between the field bus and the HART bus, the available power can be utilized more efficiently, enabling one or two additional HART devices to be powered by the field bus.

The person skilled in the art realizes that the present invention by no means is limited to the preferred embodiments described above. On the contrary, many modifications and variations are possible within the scope of the appended claims. For example, the details of the circuit diagrams described may be modified, as long as the functionality of the first and second power supply circuitry is provided. Although an embodiment of the invention has been described with reference to a radar level gauge, this is only an example, and many other devices and process instruments can advantageously be provided with a field bus interface according to the invention.

1. A field bus interface for connecting a device to a field bus, said interface being arranged to draw a constant supply current equal to a predefined bus current from the bus at a bus voltage within a predefined bus voltage range, comprising:
communication circuitry for providing communication via the field bus,
first power supply circuitry connected to said field bus and arranged to provide said communication circuit with a predefined communication power at a predefined drive voltage, said drive voltage being lower than a lower limit of said bus voltage range, and
second power supply circuitry connected to said field bus and arranged to provide a processing circuitry with processing power at said bus voltage only when a power available from said field bus exceeds said communication power.

2. The bus interface according to claim 1, further comprising a detector for detecting a surplus power, corresponding to said available power reduced by said communication power.

3. The bus interface according to claim 2, further comprising a controller arranged to adapt a functionality of said device in accordance with the detected surplus power.

4. The bus interface according to claim 1, wherein said second circuitry comprises an inductive impedance and a capacitive impedance connected in series between terminals of the field bus.

5. The bus interface according to claim 1, wherein said first circuitry comprises a controllable current source and a feedback path for providing said controllable current source with a feedback signal representing said supply current, said controllable current source being arranged to ensure that said supply current is equal to said predefined bus current.

6. The bus interface according to claim 5, wherein said feedback path comprises an adder for generating a control signal based on a difference between said feedback signal and a value representing said predefined bus current.

7. The bus interface according to claim 6, wherein said adder further receives a modulation timing signal, and is arranged to compensate said control signal for a communication signal modulated on said supply current.

8. The bus interface according to claim 2, wherein said detector comprises a voltage sensor, adapted to detect said bus voltage.

9. The bus interface according to claim 1, wherein said communication circuitry is arranged to provide any communication required by an applicable field bus standard.

10. The bus interface according to claim 1, wherein said lower limit of said voltage range is no more than 9 V.

11. The bus interface according to claim 1, wherein said processing circuitry is arranged to interface said device.

12. The bus interface according to claim 11, wherein said processing circuitry is arranged to interface a current loop.

13. The bus interface according to claim 11, wherein said processing circuitry is arranged to interface a HART bus, the bus interface thereby adapted to function as a gateway between a field bus and a HART bus.

14. A radar level gauge for measuring a process variable of a product in a tank, comprising
a transceiver for transmitting and receiving electromagnetic signals,
a propagation device arranged to allow said transmitted signal to propagate towards a surface of said product, and to return a reflected signal to the transceiver, measurement circuitry for determining said process variable based on a relationship between said transmitted signal and said received signal, and
a field bus interface arranged to draw a constant supply current equal to a predefined bus current at a bus voltage within a predefined bus voltage range, said field bus interface including:
communication circuitry for providing communication with the field bus,
first power supply circuitry connected to said bus voltage and arranged to provide said communication circuit with a predefined communication power at a predefined drive voltage, said drive voltage being lower than a lower limit of said bus voltage range, and
second power supply circuitry connected to said bus voltage and arranged to provide said radar level gauge with processing power at said bus voltage when an available power level exceeds said communication power.

101-114. (canceled)
